(19) United States
(12) Patent Application Publication
(10) Pub. No.: US 2006/0097539 A1
(43) Pub. Date: May 11, 2006

(54) Inherently rigid instrument carrier assembly

(76) Inventors: Johannes Noisternig, BRUNNENTHAL (AT); Marcel Kuhn, Walldurn (DE)

Correspondence Address: WILLIAM COLLARD;COLLARD & ROE, P.C., 1077 NORTHERN BOULEVARD, ROSLYN, NY, 11576, US

(21) Appl. No.: 10/520,214

(22) PCT Filed: Jun. 14, 2003
(86) PCT No.: PCT/EP03/06303

§ 371 Date: Aug. 8, 2005

(30) Foreign Application Priority Data
Jul. 5, 2002 (DE) 102 30 410.6

(51) Int. Cl. B62D 25/14

(52) U.S. Cl. 296/70

(57) ABSTRACT

The invention relates to an inherently rigid instrument carrier assembly that is used as a structural or styling element, in particular in motor vehicles. Said assembly replaces the support mounts that conventionally run between support elements, such as the A-pillars of a motor vehicle. The inventive assembly comprises a molded part configured as an upper shell and a molded part configured as a lower shell, consisting of fibre-reinforced thermoplastic, which is formed, in particular in a deep-drawing process, into the structure of the upper shell and the lower shell, producing at least one respective reinforcement profile that extends in the longitudinal direction of the molded part, i.e. between the support elements. Said reinforcement profile comprises at least one respective substantially vertical strut and at least one tranversal limb extending transversally to said strut. The vertical struts of the shells in particular are used to connect the two molded parts, in particular by means of plastic welding.

The invention relates to an inherently rigid instrument holder assembly, particularly one that serves as a structural or styling element, of the type mentioned in the preamble of claim 1.

A device of this type, serving as an instrument panel or carrier, is already known (EP 0 662 900 B1), which consists of a profiled part that extends in its longitudinal direction, and can be connected with support elements, for example the A pillars of a motor vehicle, at their longitudinal ends. The instrument panel serves to accommodate instruments, displays, radio, glove compartment, airbag, and steering column with the related instrument systems. In this connection, this known device consists of fiber-reinforced thermoplastic plastic, such as fiberglass-filled polyurethane, which is brought into the profiled and structured shape using the so-called SRIM technology, by means of injection molding. It has been shown that aside from difficulties during reactive injection molding, a relatively great material requirement is necessary in order to achieve sufficient structural stability of the device with regard to bending and twisting (torsion), particularly by means of load introduction by way of the steering column.

Furthermore, it is also known (EP 0 083 701 A2) to structure an instrument panel carrier of several individual parts, each of which has been formed using thermoplastic material, by means of injection molding or transfer molding. In this connection, several structural parts are connected with one another in such a manner that they form a carrier in which two outer parts follow a center part; the modular series comprised of the two outer parts and the center part forms the total carrier. In order to avoid or reduce vibrations of the individual parts as much as possible, a thin foam material layer is laid between the individual parts, in each instance. This multi-segment carrier is also not entirely satisfactory.

The invention is based on the task of improving an inherently rigid device of this type in such a manner that the carrier is so inherently rigid and structurally stable, in and of itself, without additional support carriers between the support elements of a motor vehicle, for example, that it withstands stress, even that caused by the application of force to the steering column, without impairing its function, and furthermore guarantees the requirements of safety technology, and can be produced with the lowest possible material requirement and low production costs. Good disposability is also desirable.

The invention is characterized in claim 1 and preferred embodiments are claimed in the dependent claims. Furthermore, additional improvements of the invention are evident from the drawing and the following description; the right to claim these in additional claims is reserved.

The principle of the invention provides that the bearing and supporting parts are formed in the form of two molded parts, an upper shell and a lower shell, which essentially consists of organic sheet material. “Organic sheet material” is understood to mean a further development of the GMT (fiberglass mat reinforced thermoplastic) technology. This is understood to mean semi-finished products made of thermoplastic plastic, in the form of strips or panels, having fiber reinforcements, particularly in the form of woven fabrics, but also non-woven fabrics or 2D or 3D textiles, which can be deformed, particularly when heated.

Both molded parts have at least one reinforcement rib that extends in their longitudinal direction, i.e. in the direction between the support elements, for example the A pillars of a motor vehicle. The reinforcement rib has at least one vertical ridge that is essentially vertical, and at least one crosswise shank that extends essentially perpendicular to it. It has been shown that this profiling of the reinforcement rib makes an outstanding contribution to the reinforcement of the molded parts.

Furthermore, at least one of the shells can be connected with at least one reinforcement rib made of plastic. In this connection, it is recommended to use the same thermoplastic plastic, particularly the same fiber-reinforced plastic, as for the organic sheet material.

It is practical if the connection between the upper shell and the lower shell, i.e. the two molded parts, is made along the reinforcement rib, over its area, specifically along the vertical ridges of the latter. In this connection, bonding is recommended, particularly using the friction bonding method, in which the surface of the thermoplastic melts due to heating that occurs during friction, and as a result, the two vertical ridges that were contacted with one another are firmly connected with one another after cooling.

In accordance with another embodiment of the invention, it is recommended to add either an additional vertical shank at the crosswise shanks, to form a U profile, or an additional crosswise shank at the vertical ridge, to form a T or I profile. The deep-drawing method of the semi-finished product consisting of organic sheet material is also recommended for shaping these profiled reinforcement ribs.

The vertical ridge of the reinforcement rib can also serve to attach tunnel supports.

For the attachment of additional elements, or attachment on additional elements, and for the guidance of units, such as a radio receiver or a mobile telephone, attachment or guide elements made of plastic can be attached to the upper shell and/or the lower shell, using the injection molding method or the transfer molding method.

It is also possible to configure reinforcement ribs as a deformation element, which deform when specific forces occur, and then also permit deformation of the shell part in question.

Furthermore, according to a special embodiment of the invention, it is practical to provide the upper shell with a planned breaking line at the installation location of an airbag, so that this part of the upper shell serves as an integrated airbag lid that tears open along the planned breakage line when the airbag is triggered. This line can be formed by a pre-finished organic sheet material region. However, it is also possible to use a pre-cut part (tailored blank) in which at least approximately 90% of the reinforcement fibers or reinforcement filaments of the woven fabric run in the longitudinal direction of the vehicle, in other words crosswise to the longitudinal direction of the molded part, while the region of the organic sheet material around the tailored blank has at least one woven fabric layer having approximately the same number of warp and weft threads.

The use of organic sheet materials also makes it possible to finish them, during the production of the semi-finished products, in such a manner that certain regions are less rigid than others, so that under pressure, deformable regions form, in order to better absorb the impact of body parts of passengers.

Furthermore, it is also possible to form regions, particularly line-shaped regions, of the organic sheet material as a “hinge,” so that upon impact, pivoting or bending of the adjacent region along a defined line is made possible. The hinge formation is achieved by means of a particular sizing of the woven fabric reinforcement with reference to the plastic.

The upper shell, in particular, is provided with scoops and/or grooves, thereby creating storage spaces or tray areas and/or making construction spaces for accommodating instrument panel components available. For the accommodation of decorative strips or storage compartments that can be opened, the upper shell edge facing the passengers should have cut-outs in the organic sheet material that are supported with injection-molded ribs, in the form of ridges.

According to a particular embodiment of the invention, the upper shell is provided with depressions to accommodate the airbag module both on the driver's side and on the front passenger's side. Furthermore, it is also advantageous if the upper shell is provided with a scoop that can be bonded on, both on the driver's side and on the front passenger's side, so that the arrangement of the steering column and the front passenger's airbag can be re-fitted, in simple manner, for the motor vehicles to be used in Great Britain, for example, for left-side traffic. This results in RD/LD symmetry (right-side driver/left-side driver).

It is understood that the upper shell, and the lower shell, if necessary, can be provided with a covering on the surface facing the passengers, in order to produce specific color or structural effects, whereby reflections are reduced and esthetic aspects can be better taken into consideration, for example. Such an individually selected covering makes it possible to always use the same material for the organic sheet material, in order to thereby run production in more cost-effective and environmentally friendly manner, independent of special customer requests.

Such covering can, as is known, also be filled with foam material, which not only improves the optical properties but also serves as impact protection, or actually allows certain spots to be pressed in, for example during assembly. PUR foam, for example, which is covered with a thin skin on the surfaces facing the passengers, is particularly suitable for this purpose, and for this reason, such a covering material is also referred to as an “integral foam.”

The molded parts formed according to the invention, made of fiber/plastic laminate, together with the reinforcement ribs set onto them, then form a so-called “FPL hybrid” consisting of the original sheet-like woven fabric reinforced plastic semi-finished product, which is deformed to produce the desired 3D contour, using a process derived from deep-drawing of metals, and then completed with LFT injection molded components that are injection-molded on or bonded on.

The production of organic sheet material can take place using autoclaves and/or double-belt presses, so that specially produced semi-finished products having regions of differing rigidity or strength can be produced by variations, for example of the type of woven fabric (number of looping points, thread diameter, number of threads in the warp and weft direction) and the number of woven fabric layers between films of plastic polymer (local change in thread density or fiber volume content).

The invention therefore offers an instrument panel that takes over the support function between the A pillars, according to the principle of a flowing surface contour, with depressions instead of bores and a cross-section combination of reinforcement ribs having a T or U hollow profile, in particular, having great structural strength and rigidity.

Exemplary embodiments of the invention will now be discussed using the drawing. This shows:

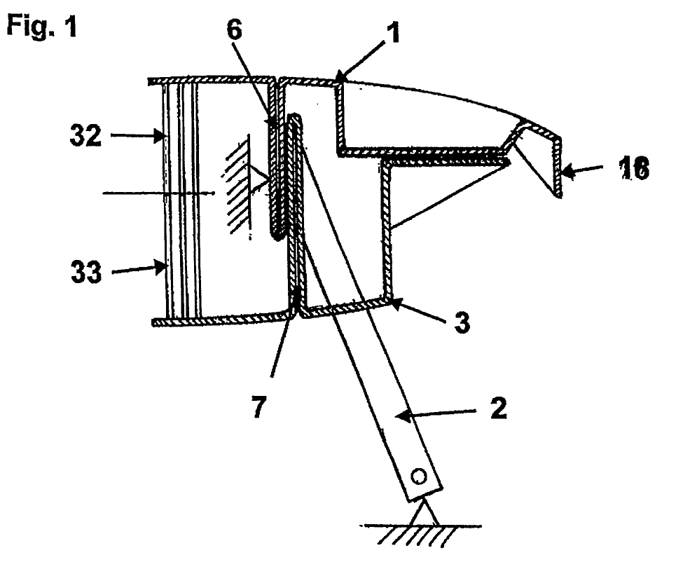

FIG. 1, in a side view, an upper shell 1 with a lower shell 3 and a tunnel support 2;

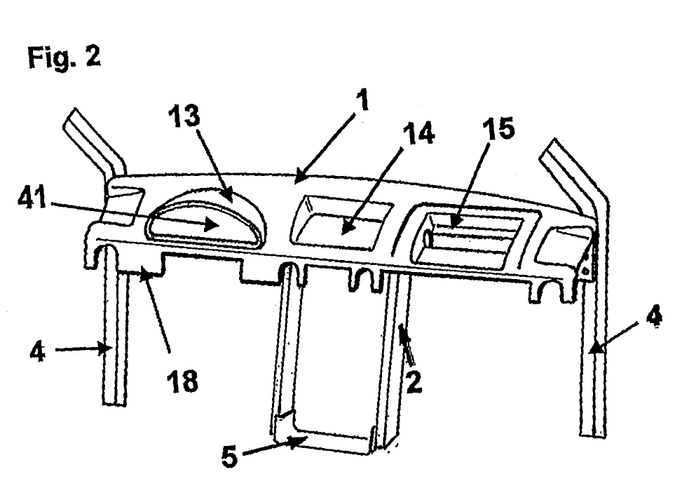

FIG. 2, a top view of an upper shell 1 clamped between the support elements 4, to which shell two tunnel supports 2 are attached, which are supported on the car body tunnel 5;

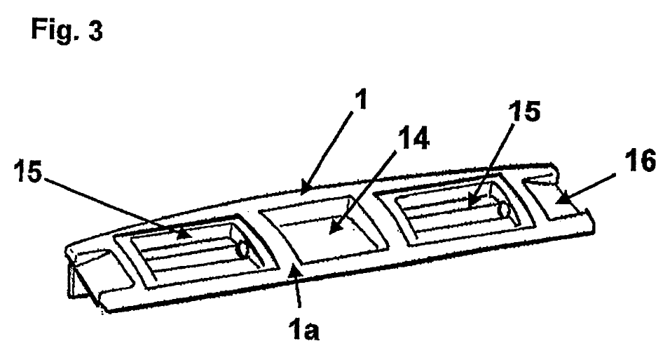

FIG. 3, the top la of the upper shell 1, and

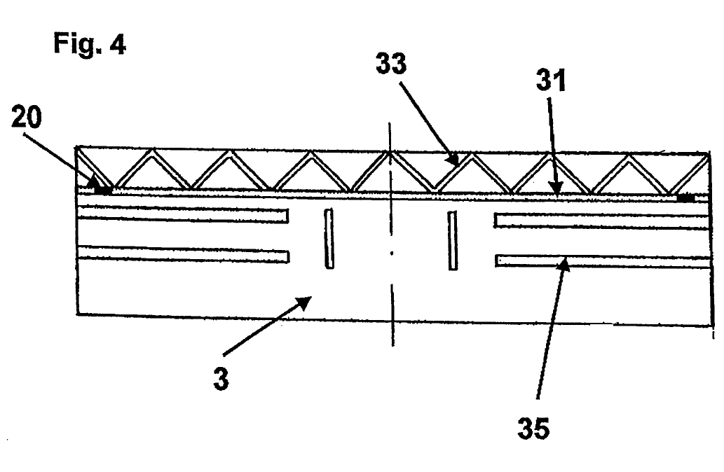

FIG. 4, the top of the lower shell 3;

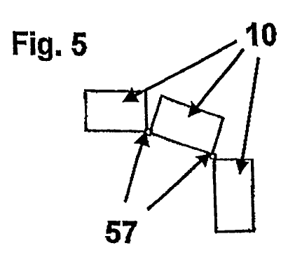

FIG. 5, a three-segment controller unit;

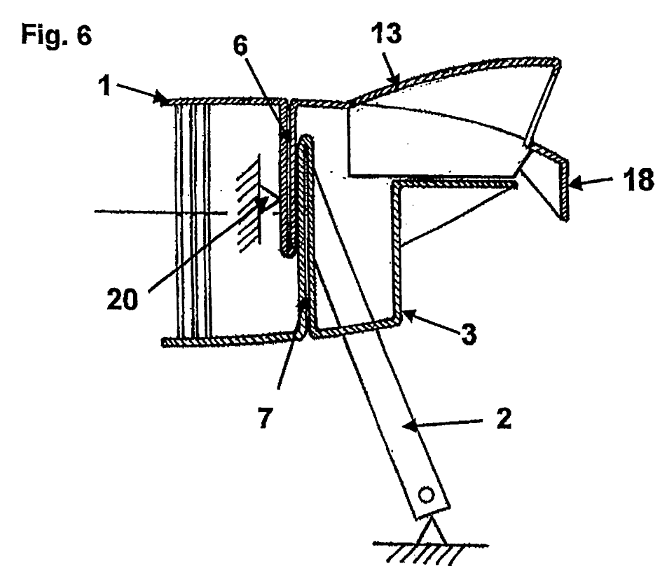

FIG. 6, a schematic cross-section through the assembly that serves as the carrier for instruments and, under some circumstances, other units;

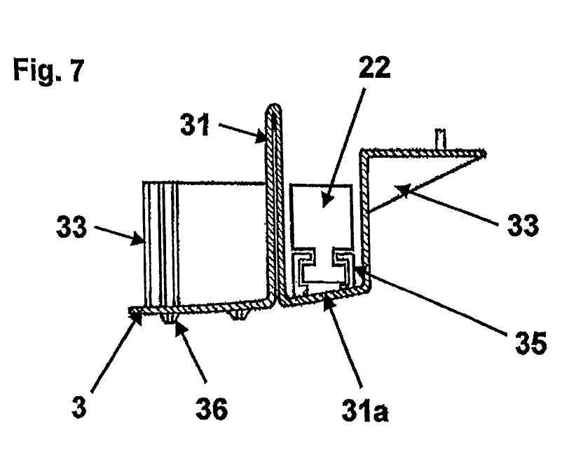

FIG. 7, a partial cross-section through a reinforcement rib;

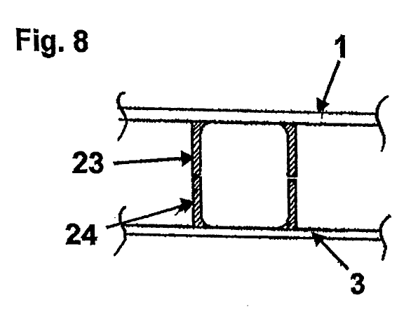

FIG. 8, a schematic representation of the woven fabric reinforcement and tailored blank of the upper shell, and

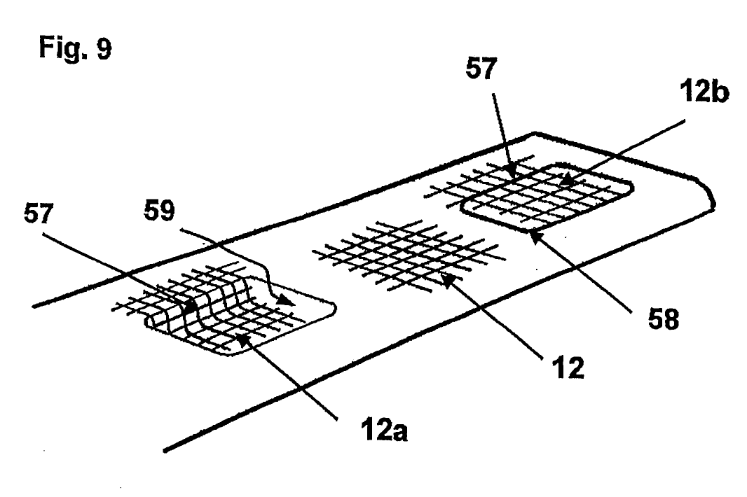

FIG. 9, a partial cross-section through an air channel.

According to FIG. 1, the assembly serving as an instrument panel or as an instrument carrier consists of the upper part 1 and the lower part 3, specifically along reinforcement profiles 6 and 7 that are only indicated schematically here, each of which has a vertical ridge 31, according to the example in FIG. 7, from which ridge crosswise shanks 31a project approximately at a right angle, i.e. horizontally.

A scoop 13 is set into the recess 41 shown in FIG. 2, in such a manner that its hood-like upper part rises above the surface of the upper shell 1, in an upward direction.

Furthermore, the upper shell 1 and the lower shell 3 have a reinforcement rib 32 and 33, the cross-shaped structure of which is even better evident in FIG. 4, namely from the top of the lower shell 3.

The upper shell 1 is deep-drawn from the organic sheet material, in such a manner that not only the aforementioned reinforcement profile 6 and, if applicable, reinforcement ribs on the inside, but also trough-shaped depressions 14, 15, 16 are formed, of which the trough-shaped depression 17 can be used to accommodate an airbag element. On the upper shell 1, guide elements 18 are furthermore disposed on the edge facing the passengers, which can serve to attach additional units.

The lower shell 3 of FIG. 4 is provided with load introduction elements 20 at the ends, which can be used for attachment to the support elements 4 or A pillars. In the vicinity of these load introduction elements 20, in the region of the ends of the vertical ridge 31, guide rails 35 are disposed to accommodate controller units 22 or electrical/electronic units.

According to FIGS. 4 and 7, a segmented controller unit is housed in the cavity of the inherently rigid instrument holder assembly, the segments 10 of which unit are connected with one another, in pivoting manner, by means of hinge joints 57, so that if service for the electrical/electronic unit, for example, is required, access is possible with the vehicle door open and without disassembly of the cockpit module or the inherently rigid instrument holder assembly.

It is understood that lines can also be integrated into the instrument panel or instrument carrier.

According to FIG. 8, a cavity is formed by the ridges 23 and 24 molded onto the upper shell 1 and the lower shell 3, which cavity can be used as an air guide, for example.

In FIGS. 6 and 7, the progression of the organic sheet material formed to produce reinforcement profiles 6, 7 is shown schematically, thereby forming a type of T at the top and a type of U and T, in cross-section, at the bottom. The organic sheet material of polypropylene or polyamide, for example, is reinforced with a woven fabric insert 12 of fiberglass or carbon fiber woven fabric.

According to FIG. 9, a woven fabric reinforcement 12 of inorganic and/or organic fibers of the thermoplastic organic sheet material, formed to produce the upper shell 3 can be seen schematically. Instead of the woven fabric shown in the drawing, any 2D or 3D textiles as well as non-woven fabrics in many different combinations can be used. Here, special pre-cut parts 12a, 12b (tailored blanks) can form defined deformation regions 59 or break-up lines 58 for fulfilling safety technology requirements, particularly when using textiles having fiber components 12b oriented predominantly in the longitudinal vehicle direction.

1. (canceled)

2. The assembly as recited in claim 23, wherein the organic sheet material comprises a thermoplastic reinforced with a fiber woven fabric.

3. The assembly as recited in claim 2, wherein the at least one reinforcement rib is formed from the same thermoplastic as the organic sheet material.

4. The assembly as recited in claim 20, wherein said at least one strut comprises a plurality of substantially vertical struts connecting the upper shell and the lower shell with one another.

5. The assembly as recited in claim 4, wherein the upper shell is bonded or melted to the lower shell.

6. The assembly as recited in claim 5, wherein the bonding of the upper shell to the lower shell takes place by way of friction bonding.

7. The assembly as recited in claim 23 further comprising tunnel supports attached to the vertical strut.

8. The assembly as recited in claim 20 further comprising attachment elements or guide elements made of plastic and molded onto the upper shell or the lower shell by injection molding or transfer molding.

9. The assembly as recited in claim 21, wherein said at least one reinforcement rib comprises a plurality of deformation elements, which deform when forces occur and then also permit deformation of a corresponding shell part.

10. The assembly as recited in claim 20, wherein the upper shell is provided with scoops or depressions for forming storage spaces or tray spaces or for accommodating instrument panel components, airbag modules, loudspeakers, or similar instrument panel parts.

11. The assembly as recited in claim 23, wherein the upper shell has an upper shell edge that faces the passengers, said upper shell edge having ridge-shaped cut-outs, supported with injection-molded ribs, in the organic sheet material, to accommodate decorative strips or storage compartments that can be opened.

12. The assembly as recited in claim 2, wherein the upper shell has depressions to accommodate an airbag module both on the driver's side and the front passenger's side.

13. The assembly as recited in claim 20, wherein a scoop is bonded onto the upper shell on the driver's side.

14. The assembly as recited in claim 12, wherein the upper shell follows the depression formation at the installation location of the airbag, and is provided with a planned tear-open seam of the integrated airbag lid.

15. The assembly as recited in claim 14, wherein the planned tear-open seam is formed by a pre-finished organic sheet material region.

16. The assembly as recited in claim 14, wherein said at least two molded parts are substantially formed from organic sheet material and the planned tear-open seam (58) is formed by a pre-cut tailored blank in which at least approximately 90% of the reinforcement fibers or reinforcement filaments of the woven fabric run crosswise to the longitudinal direction of the molded part, while the region of the organic sheet material around the tailored blank has at least one woven fabric layer having approximately the same number of warp and weft threads.

17. The assembly as recited in claim 23, wherein the upper shell has planned tear-open locations or regions that are deformable under pressure, in order to absorb the impact of body parts of passengers.

18. The assembly as recited in claim 17, wherein organic sheet material regions of the upper shell comprise woven fabric hinges that permit pivoting or bending of the adjacent region in case of an impact.

19. The assembly as recited in claim 20, wherein the top of at least the upper shell, facing the passengers, is provided with a covering that has a plastic foam material at least in certain regions.

20. An instrument holder assembly comprising at least two molded parts for attachment to support elements of a motor vehicle, said at least two molded parts comprising an upper shell and a lower shell, each of said upper shell and said lower shell comprising at least one respective reinforcement profile comprising at least one strut and at least one transverse limb extending transversely to said strut.

21. The assembly as recited in claim 20 further comprising at least one reinforcement rib provided on a member selected from the group consisting of said upper shell and said lower shell.

22. The assembly as recited in claim 20 wherein said at least two molded parts are formed from fiber-reinforced plastic.

23. The assembly as recited in claim 21 wherein:
said at least two molded parts are substantially formed from organic sheet material which is shaped by a deep-drawing process into said upper shell and said lower shell;
said at least one respective reinforcement profile extends in a longitudinal direction of the corresponding molded part;
said at least one strut comprises a vertical strut extending substantially vertically; and
said at least one reinforcement rib is formed from fiber-reinforced plastic.
